(19) United States
(12) Patent Application Publication
(10) Pub. No.: US 2007/0237118 A1
(43) Pub. Date: Oct. 11, 2007

(54) Method and apparatus of acquiring time information in a mobile communication terminal

(75) Inventor: Jong-Won Seo, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/729,012

(22) Filed: Mar. 28, 2007

(30) Foreign Application Priority Data
Mar. 31, 2006 (KR) 2006-0029421

(51) Int. Cl. H04B 7/216

(52) U.S. Cl. 370/335

(57) ABSTRACT

Provided is a method and apparatus for acquiring time information from a CDMA system in a mobile communication terminal. The method includes: searching for a CDMA channel in a predetermined manner when a CDMA modem or module is activated; receiving a sync channel signal via the searched CDMA channel and extracting time information from the sync channel signal; and setting a time of the mobile communication terminal using the extracted time information. Therefore, even when the mobile communication terminal communicates with a system that does not provide time information, the mobile communication terminal can precisely maintain its time by acquiring time information from a CDMA system.

### PRIORITY

This application claims priority under 35 U.S.C. § 119 to an application filed in the Korean Intellectual Property Office on Mar. 31, 2006 and allocated Serial No. 2006-29421, the contents of which are incorporated herein by reference.

### BACKGROUND OF THE INVENTION

1. Field of the Invention

The present invention relates generally to a mobile communication terminal, and more particularly, to a method and an apparatus for acquiring time information from a synchronous system such as a code division multiple access system.

2. Description of the Related Art

The second generation (2G) mobile communication system and method mainly involves voice services and includes a Global System for Mobile communications (GSM) and an Interim Standard 95 (IS-95). The GSM service has been commercialized mainly in Europe since 1992. The GSM service is based on a Time Division Multiple Access (TDMA) method. The IS-95 service has been commercialized mainly in Korea and the U.S.A. using a Code Division Multiple Access (CDMA) method.

Meanwhile, the third generation (3G) mobile communication system and method supports packet services as well as voice services. The third generation mobile communication service is based on the CDMA method. The third generation mobile communication method includes a 3rd Generation Project Partnership (3GPP) or Wideband Code Division Multiple Access (WCDMA) method, and 3rd Generation Project Partnership 2 (3GPP2) or CDMA2000 method. The 3GPP or WCDMA method utilizes asynchronous inter-base station operation and is selected as a standard 3 G communication method in Europe and Japan. The 3GPP2 or CDMA2000 method utilizes synchronous inter-base station operation and is selected as a standard 3 G communication method in the U.S.A. The 3GPP proposes Frequency Division Duplex (FDD) and Time Division Duplex (TDD) for uplink/downlink transmission in order to efficiently use limited channel resources.

With the development of communication technologies, various mobile communication systems employing various communication schemes have been commercialized. That is, the current mobile communication environment is subjected to various communication schemes. For this reason, terminals compatible with a plurality of communication schemes have been developed. For example, referring to FIG. 1, a WCDMA cell 100 and a CDMA cell 110 overlap each other, and a mobile terminal 101 compatible with WCDMA and CDMA methods has been developed for use in that communication environment.

Meanwhile, the time of a mobile communication terminal can be set manually by a user or automatically set using time information contained in an air message received from a communication service provider. In a mobile communication terminal compatible with at least one communication method, for example, a mobile communication terminal compatible with WCDMA and CDMA methods, an operation for calculating and setting time is performed each time the terminal switches between WCDMA and CDMA since WCDMA and CDMA systems provide different time information.

Although the CDMA system sends exact time information to the mobile communication terminal, the WCDMA system may not send time information to the mobile terminal or may send non-exact time information. Therefore, it is difficult for the mobile communication terminal to precisely maintain its time while operating in the WCDMA mode.

Further, in the case of a mobile communication terminal supporting GSM/GPRS (General Packet Radio Service), a user must manually set the time of the mobile communication terminal since the GSM/GPRS system does not provide time information.

### SUMMARY OF THE INVENTION

An object of the present invention is to substantially solve at least the above problems and/or disadvantages and to provide at least the advantages below. Accordingly, an object of the present invention is to provide a method and an apparatus for acquiring time information from a CDMA system in a mobile communication terminal.

Another object of the present invention is to provide a method and an apparatus for acquiring time information from a CDMA system in a mobile communication terminal having at least one modem chip compatible with CDMA and GSM/GPRS/WCDMA systems. Although the GSM/GPRS/WCDMA system does not always provide time information, the mobile communication terminal can precisely maintain its time while operating in GSM/GPRS/WCDMA mode by acquiring time information from the CDMA system.

A further another object of the present invention is to provide a method and an apparatus for acquiring time information from a CDMA system, periodically or when a call is set up or when power is applied, in a mobile communication terminal.

A still further another object of the present invention is to provide a method and an apparatus for a mobile communication terminal to use time information of a CDMA system prior to use of time information of a GSM/GPRS/WCDMA system.

According to one aspect of the present invention, a method of acquiring time information from a CDMA (Code Division Multiple Access) system in a mobile communication terminal includes searching for a CDMA channel in a predetermined manner when a CDMA modem or module is activated; receiving a sync channel signal via the searched CDMA channel and extracting time information from the sync channel signal; and setting a time of the mobile communication terminal using the extracted time information.

According to another aspect of the present invention, a method of acquiring time information from a CDMA system in a mobile communication terminal includes when the mobile communication terminal operates in a call mode and receives a handover command message containing information about a CDMA channel from a network, determining whether a call ends; if so, activating a CDMA modem or module; receiving a sync channel signal via the CDMA channel and extracting time information from the sync channel signal; and setting a time of the mobile communication terminal using the extracted time information.

According to a further another aspect of the present invention, a method of setting a time of a mobile communication terminal depending on a type of acquired time information includes when time information is received from a CDMA system, setting the time of the mobile communication terminal using the time information; and if time information is not received from a CDMA system, determining whether time information is received from another system, and if so, setting the time of the mobile communication terminal using the time information received from another system.

### BRIEF DESCRIPTION OF THE DRAWINGS

The above and other objects, features and advantages of the present invention will become more apparent from the following detailed description when taken in conjunction with the accompanying drawings in which:

FIG. 1 shows an example of a mobile communication environment using different communication methods;

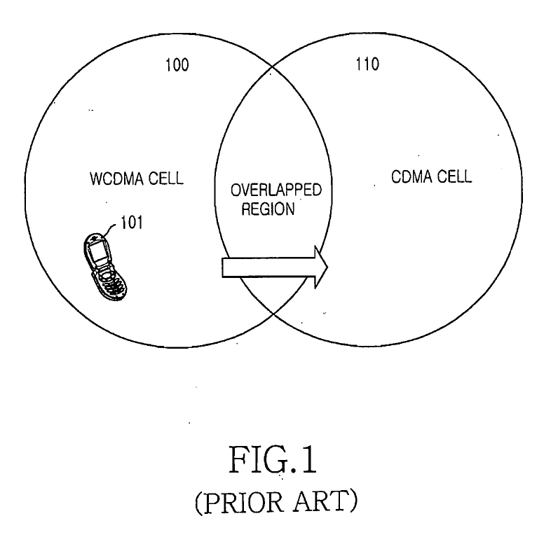

FIGS. 2A and 2B are block diagrams of mobile communication terminals each compatible with different mobile communication systems according to the present invention;

FIG. 3 is a flowchart illustrating a method of acquiring time information from a CDMA system in a mobile communication terminal according to a first embodiment of the present invention;

FIG. 4 is a flowchart illustrating a method of acquiring time information from a CDMA system in a mobile communication terminal according to a second embodiment of the present invention; and

FIG. 5 is a flowchart for explaining a method of setting the time of a mobile communication terminal based on the type of acquired time information according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Hereinafter, a method of acquiring time information from a CDMA system in a mobile communication terminal will now be more fully described according to the present invention. CDMA system is a synchronous system and sends exact time information to the mobile communication terminal.

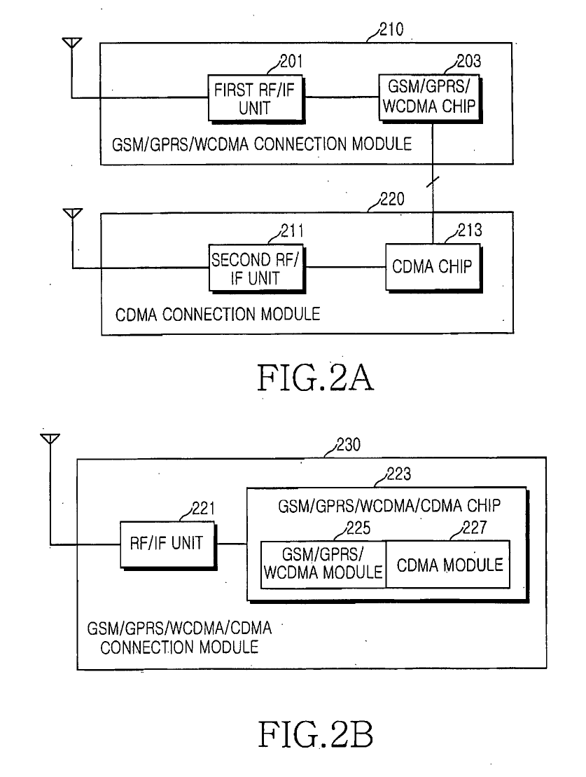

FIGS. 2A and 2B are block diagrams of mobile communication terminals each compatible with different mobile communication systems according to the present invention. Referring to FIG. 2A, the mobile communication terminal includes at least one modem chip supporting a single communication method such that the mobile communication terminal can be used for at least one communication method. Referring to FIG. 2B, the mobile communication terminal includes a single modem chip supporting at least one communication method such that the mobile communication terminal can be used in at least one communication method.

For example, the mobile communication terminal of FIG. 2A includes two modem chips, one for GSM/GPRS/WCDMA and the other for CDMA. Hereinafter, this mobile communication terminal will be referred to as a two-chip mobile communication terminal. In detail, the two-chip mobile communication terminal includes a GSM/GPRS/WCDMA connection module 210 and a CDMA connection module 220. The GSM/GPRS/WCDMA connection module 210 includes a first RF/IF unit 201 and a GSM/GPRS/WCDMA modem chip 203 so as to support the GSM/GPRS/WCDMA method. The CDMA connection module 220 includes a second RF/IF unit 211 and a CDMA modem chip 213 so as to support the CDMA method.

In another example, the mobile communication terminal of FIG. 2B uses only one modem chip for GSM/GPRS/WCDMA and CDMA methods. Hereinafter, this mobile communication terminal will now be referred to as a single-chip mobile communication terminal. In detail, the single-chip mobile communication terminal includes a GSM/GPRS/WCDMA/CDMA connection module 230 supporting both the GSM/GPRS/WCDMA and CDMA methods. The GSM/GPRS/WCDMA/CDMA connection module 230 includes a GSM/GPRS/WCDMA/CDMA modem chip 223 and an RF/IF unit 221. The GSM/GPRS/WCDMA/CDMA modem chip 223 includes a GSM/GPRS/WCDMA module 225 and a CDMA module 227.

When the mobile communication terminals are in a particular communication service area such as a GSM/GPRS/WCDMA service area or a CDMA service area, a corresponding connection chip 210, 220, or 230 transmits and receives signals using its modem chip 203, 213, or 223 according to the particular communication method. For example, referring to FIG. 2A, when the two-chip mobile communication terminal is powered-on or is carried into a particular communication service area, one of the modem chips 203 and 213 corresponding to the current communication service is booted, and the connection module 210 or 220 having the booted modem chip is activated to transmit and receive signals. In another example, referring to FIG. 2B, when the single-chip mobile communication terminal is powered-on in a particular communication service area, the modem chip 223 is booted, and one of the modules 225 and 227 of the connection module 230 corresponding to the current communication service is activated to transmit and receive signals in accordance with the current communication service.

Each of the RF/IF units 201, 211, and 221 decreases the frequency of a RF (radio frequency) signal received through an antenna, performs de-spreading and channel-decoding on the signal, and then sends the signal to a corresponding modem chip 203, 213, or 223. Further, each of the RF/IF units 201, 211, and 221 performs channel coding and spreading on a signal, increases the frequency of the signal, and then transmits the signal through the antenna.

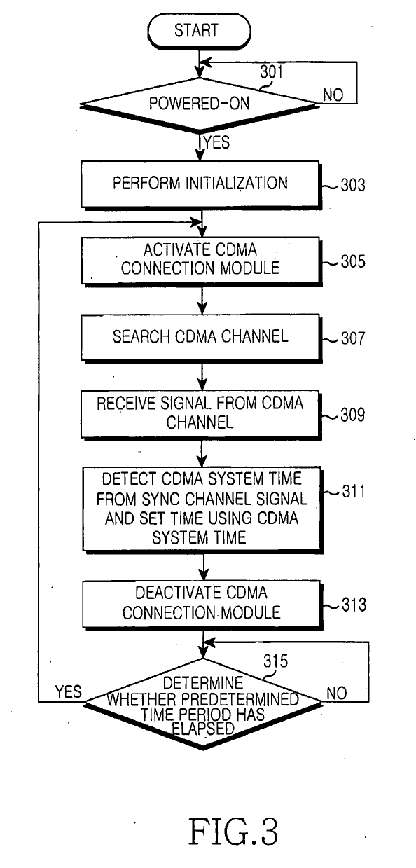

FIG. 3 is a flowchart illustrating a method of acquiring time information from a CDMA system in a mobile communication terminal according to a first embodiment of the present invention. The current embodiment describes the time information acquiring method when the mobile communication terminal is in, for example, a non-CDMA service area (serving cell) such as a WCDMA service area. Further, the current embodiment describes the time information acquiring method for a two-chip mobile communication terminal compatible with WCDMA and CDMA methods, for example. However, the present invention is not limited to this embodiment. For example, the method of the present invention can be used for various mobile communication terminals such as a single-chip mobile communication terminal that has at least one chip compatible with multiple mobile communication methods.

Referring to FIG. 3, it is determined whether the mobile communication terminal is powered-on in step 301. If so, the mobile communication terminal is initialized in step 303. In the initialization of the mobile communication terminal, to operate in the WCDMA mode, the GSM/GPRS/WCDMA connection module 210 is activated by booting the GSM/GPRS/WCDMA modem chip 203. That is, the mobile communication terminal is ready for operating in WCDMA mode. In case of the single-chip mobile communication terminal supporting GSM/GPRS/WCDMA/CDMA methods, the GSM/GPRS/WCDMA/CDMA connection module 230 is activated by booting the GSM/GPRS/WCDMA/CDMA modem chip 223 for initialization. Here, the single-chip mobile communication terminal boots only the GSM/GPRS/WCDMA module 225 for operating in GSM/GPRS/WCDMA mode.

In step 305, the CDMA connection module 220 is activated by booting the CDMA modem chip 213. In case of the single-chip mobile communication terminal supporting GSM/GPRS/WCDMA/CDMA methods, the CDMA module 227 of the GSM/GPRS/WCDMA/CDMA modem chip 223 is activated.

In step 307, the mobile communication terminal searches for a CDMA channel to find a surrounding CDMA system. The mobile communication terminal can search for the CDMA channel using three methods. In a first method, since the frequency band of the CDMA service in one country is largely different from one service provider to another, all frequency ranges used for CDMA are searched at predetermined intervals corresponding to the representative width of frequency bands of CDMA service providers. Further, since only predetermined portions of each CDMA frequency band are used for CDMA channels, the mobile communication terminal finds an available CDMA channel by searching a CDMA frequency band having at least one operating frequency. In other words, the mobile communication terminal detects the frequency bands of CDMA providers and determines the first CDMA channel found in the detected frequency bands as the available CDMA channel of the surrounding CDMA system. Here, since the width of the frequency bands of CDMA service providers are different from one country to another, the representative width of the frequency bands of CDMA service providers are determined by the bandwidth of a most frequently used frequency band of the communication service providers.

In a second method, CDMA channel lists are stored in the mobile communication terminal for each CDMA service providing country, and the mobile communication terminal receiving the GSM/GPRS/WCDMA service determines the current country using a Mobile Country Code (MCC) and a Mobile Network Code (MNC). Then, the mobile communication terminal finds an available CDMA channel using the CDMA channel list corresponding to the current country.

When the use of the mobile communication terminal is limited to a domestic area or a particular country, the mobile communication terminal stores a Preferred Roaming List (PRL) containing CDMA channel information. Therefore, in a third method, the mobile communication terminal searches for an available CDMA channel by starting with a channel having the highest priority in the PRL.

In step 309, the mobile communication terminal receives signals from the searched CDMA system through a pilot channel, a sync channel, and a paging channel. In step 311, the mobile communication terminal detects time information from the sync channel signal received from the CDMA system and sets its time using the detected CDMA system time. In step 313, the CDMA connection module 220 is deactivated. In the case of the single mobile communication terminal supporting the GSM/GPRS/WCDMA/CDMA methods, the CDMA module 227 of the GSM/GPRS/WCDMA/CDMA modem chip 223 may be deactivated to deactivate the GSM/GPRS/WCDMA/CDMA connection module 230.

In step 315, the mobile communication terminal determines whether a predetermined time period has elapsed. If so, the mobile communication terminal proceeds back to step 305 where the CDMA connection module 220 is activated. The mobile communication terminal performs the next steps in the same way to receive CDMA system time and reset its time using the newly received CDMA system time. After that, the mobile communication terminal terminates the process shown in FIG. 3.

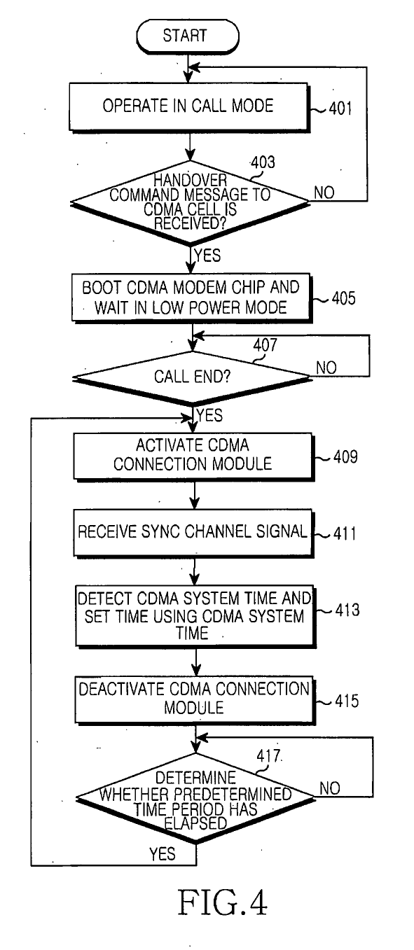

FIG. 4 is a flowchart illustrating a method of acquiring time information from a CDMA system in a mobile communication terminal according to a second embodiment of the present invention. The current embodiment describes the case where a mobile communication terminal ends a call and acquires CDMA system time when the mobile communication terminal receives a handover command to a CDMA cell from a network in call mode. The current embodiment describes the time information acquiring method when the mobile communication terminal is in, for example, a non-CDMA service area (serving cell) such as a WCDMA service area. Further, the current embodiment describes the time information acquiring method for a two-chip mobile communication terminal compatible with WCDMA and CDMA methods, for example. However, the present invention is not limited to this embodiment. For example, the method of the present invention can be used for various mobile communication terminals such as a single-chip mobile communication terminal that has at least one chip compatible with multiple mobile communication methods.

Referring to FIG. 4, in step 401, the mobile communication terminal operates in call mode (dedicated state) upon a user key input. Here, the mobile communication terminal periodically sends a measurement reporting message to a connected network. The network checks the call quality of the mobile communication terminal using the measurement reporting message, such that the network can determine whether a handover occurs. The measurement reporting message contains information about a serving cell and neighboring cells. In detail, from the measurement reporting message, the network acquires information about the frequency of the serving cell, the Rx signal level and Rx signal quality level from the serving cell, the number of the neighboring cells, the Rx signal level at a frequency of each of the neighboring cells, and Base Station Identity Codes (BSIC).

In step 403, it is determined whether the mobile communication terminal receives a handover command message for transferring to a CDMA cell from the network. In detail, when the network determines that the call quality of the mobile communication terminal is not good, the network selects a neighboring cell to which the mobile communication terminal is handed over with reference to the measurement reporting message and sends the handover-command to the mobile communication terminal to transfer the mobile communication terminal to another cell. The handover-command message contains newly allotted channel information for the mobile communication terminal. If the mobile communication terminal does not receive the handover command message, the mobile communication terminal continues to operate without change.

If the mobile communication terminal receives the handover command message, the mobile communication terminal proceeds to step 405 where the mobile communication terminal boots the CDMA modem chip 213 and waits in a low power mode. Meanwhile, in the case of a single-chip mobile communication terminal compatible with GSM/GPRS/WCDMA/CDMA methods, the single-chip mobile communication terminal boots the GSM/GPRS/WCDMA/CDMA modem chip 223 when it is powered-on. It is not required for the single-chip mobile communication terminal to boot the CDMA chip 227 in this step. Here, in a GSM/GPRS/WCDMA cell, the single-chip mobile communication terminal activates only the GSM/GPRS/WCDMA module 225 of the GSM/GPRS/WCDMA/CDMA modem chip 223.

In step 407, it is determined whether a key input occurs for ending the call. If so, the mobile communication terminal activates the CDMA modem chip 213 to activate the CDMA connection module 220 in step 409. In step 411, the mobile communication terminal receives signals from a pilot channel, a sync channel, and a paging channel that are allotted to the mobile communication terminal by the network. The sync channel signal contains information about CDMA system time. Meanwhile, in the case of the single-chip mobile communication terminal compatible with GSM/GPRS/WCDMA/CDMA methods, the CDMA module 227 of the GSM/GPRS/WCDMA/CDMA modem chip 223 may be activated to activate the CDMA connection module 230.

In step 413, the mobile communication terminal extracts the time information from the sync channel signal and sets its time using the extracted time information. In step 415, the CDMA connection module 220 is deactivated. In the case of the single mobile communication terminal supporting the GSM/GPRS/WCDMA/CDMA methods, the CDMA module 227 of the GSM/GPRS/WCDMA/CDMA modem chip 223 may be deactivated to deactivate the GSM/GPRS/WCDMA/CDMA connection module 230.

In step 417, the mobile communication terminal determines whether a predetermined time period has elapsed. If so, the mobile communication terminal proceeds back to step 409 where the CDMA connection module 220 is activated. The mobile communication terminal performs the next steps in the same way to receive CDMA system time and reset its time using the newly received CDMA system time. After that, the mobile communication terminal terminates the process shown in FIG. 4.

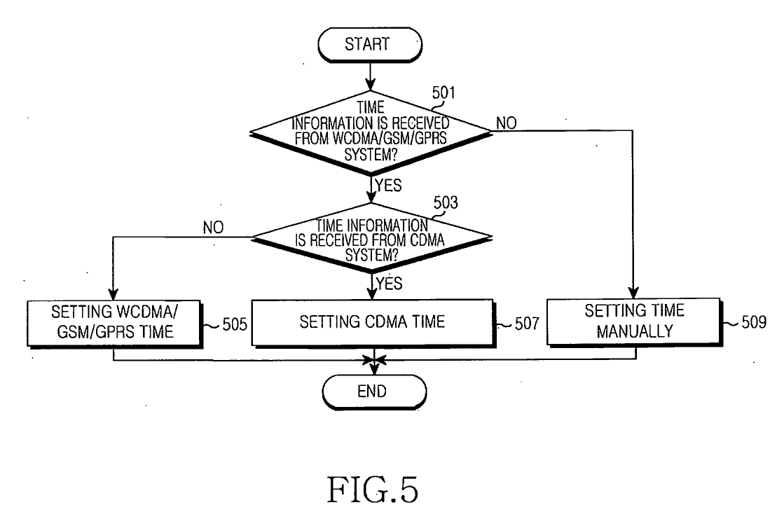

FIG. 5 is a flowchart for explaining a method of setting the time of a mobile communication terminal based on the type of acquired time information according to the present invention.

Referring to FIG. 5, in step 501, it is determined whether the mobile communication terminal receives time information from a WCDMA, GSM, or GPRS system. If not, the mobile communication terminal proceeds to step 509 where the time of the mobile communication terminal is manually set by a user using keys.

If so, the mobile communication terminal determines whether the time information is from a CDMA system in step 503. If so, the mobile communication terminal sets its time with the time information of the CDMA system in step 507. If not, the mobile communication terminal proceeds to step 505 where the time of the mobile communication terminal is set using the time information received from the WCDMA, GSM, or GPRS system. After that, the process of FIG. 5 ends.

As described above, the time acquiring method of the present invention applies to a mobile communication terminal compatible with the CDMA method and the GSM/GPRS/WCDMA method. According to the time acquiring method of the present invention, the mobile communication terminal can acquire time information from a CDMA system while operating in GSM/GPRS/WCDMA mode. Therefore, although the GSM/GPRS/WCDMA method does not always provide time information, the mobile communication terminal can precisely maintain its time while operating in GSM/GPRS/WCDMA mode since time information can be acquired from the CDMA system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of acquiring time information from a CDMA (Code Division Multiple Access) system in a mobile communication terminal, comprising the steps of:
searching for a CDMA channel when a CDMA modem or module is activated;
receiving a sync channel signal via the searched CDMA channel and extracting time information from the sync channel signal; and
setting a time of the mobile communication terminal using the extracted time information.

2. The method of claim 1, further comprising deactivating the CDMA modem or module.

3. The method of claim 1, further comprising booting and/or activating the CDMA modem or module when the mobile communication terminal is powered-on.

4. The method of claim 1, further comprising activating the CDMA modem or module at predetermined intervals.

5. The method of claim 1, wherein the CDMA module is included in a multiplex communication supporting modem of the mobile communication terminal.

6. A method of acquiring time information from a CDMA system in a mobile communication terminal, comprising the steps of:
when the mobile communication terminal operates in a call mode and receives a handover command message containing information about a CDMA channel from a network, determining whether a call ends;
if so, activating a CDMA modem or module;
receiving a sync channel signal via the CDMA channel and extracting time information from the sync channel signal; and
setting a time of the mobile communication terminal using the extracted time information.

7. The method of claim 6, further comprising booting the CDMA modem and waiting in a low power mode when the mobile communication terminal operates in the call mode and receives the handover command message containing information about the CDMA channel from the network.

8. The method of claim 6, further comprising:
deactivating the CDMA modem or module;
activating the CDMA modem or module after a predetermined time elapses;
receiving a sync channel signal via the CDMA channel and extracting time information from the sync channel signal; and
setting the time of the mobile communication terminal using the extracted time information.

9. The method of claim 6, wherein the CDMA module is included in a multiplex communication supporting modem of the mobile communication terminal.

10. A method of setting a time of a mobile communication terminal depending on a type of acquired time information, the method comprising the steps of:
when time information is received from a CDMA system, setting the time of the mobile communication terminal using the time information; and
if time information is not received from the CDMA system, determining whether time information is received from another system, and if so, setting the time of the mobile communication terminal using the time information received from the another system.

11. The method of claim 10, further comprising manually setting the time of the mobile communication terminal by a user if time information is not received.

12. A method of searching for a channel of communication system, comprising the steps of:
searching for frequency bands allotted to communication service providers in a country by dividing an entire frequency range into predetermined bandwidths; and
finding the channel of the communication system from the searched frequency bands.

13. The method of claim 12, wherein the predetermined bandwidth is equal to a bandwidth of a most frequently used frequency band of the communication service providers.

14. A method of searching for a channel of communication system, comprising the steps of:
identifying a country using a MCC (Mobile Country Code) and a MNC (Mobile Network Code); and
searching for the channel of the communication system according to the identified country using a channel list stored in a memory and sorted by country and communication system.

15. A method of acquiring time information in a mobile communication terminal communicating with both a synchronous system and an asynchronous system, comprising the steps of:
searching for a synchronous channel when a synchronous modem or module is activated;
receiving a sync channel signal via the searched synchronous channel and extracting time information from the sync channel signal; and
setting a time of the mobile communication terminal using the extracted time information.

16. A method of acquiring time information in a mobile communication terminal communicating with both a synchronous system and an asynchronous system, comprising the steps of:
when the mobile communication terminal operates in a call mode and receives a handover command message containing information about a synchronous channel from a network, determining whether a call ends;
if so, activating a synchronous modem or module;
receiving a sync channel signal via the synchronous channel and extracting time information from the sync channel signal; and
setting a time of the mobile communication terminal using the extracted time information.

17. A method of setting a time of a mobile communication terminal communicating with both a synchronous system and an asynchronous system, the method comprising the steps of:
when time information is received from a synchronous system, setting the time of the mobile communication terminal using the time information; and
if time information is not received from the synchronous system, determining whether time information is received from an asynchronous system, and if so, setting the time of the mobile communication terminal using the time information received from the asynchronous system.

18. A mobile communication terminal communicating with both a synchronous system and an asynchronous system comprising:
an apparatus for searching for a synchronous channel when a synchronous modem or module is activated, receiving a sync channel signal via the searched synchronous channel and extracting time information from the sync channel signal, and setting a time of the mobile communication terminal using the extracted time information.

19. A mobile communication terminal communicating with both a synchronous system and an asynchronous system comprising:
an apparatus for determining whether a call ends when the mobile communication terminal operates in a call mode and receives a handover command message containing information about a synchronous channel from a network and, if so, activating a synchronous modem or module, receiving a sync channel signal via the synchronous channel and extracting time information from the sync channel signal, and setting a time of the mobile communication terminal using the extracted time information.

20. A mobile communication terminal communicating with both a synchronous system and an asynchronous system comprising:
an apparatus setting the time of the mobile communication terminal using the time information when time information is received from a synchronous system, and, if time information is not received from the synchronous system, determining whether time information is received from an asynchronous system, and if so, setting the time of the mobile communication terminal using the time information received from the asynchronous system.
